(19) United States
(12) Patent Application Publication
(10) Pub. No.: US 2026/0316374 A1
(43) Pub. Date: Oct. 15, 2026

(54) LONGITUDINAL STRETCHING SYSTEM WITH A LONGITUDINAL STRETCHING MODULE

(71) Applicant: Brückner Maschinenbau GmbH, Siegsdorf (DE)

(72) Inventors: Anton EDFELDER, Unterwössen (DE); Jens ADLER, Siegsdorf (DE); Felix WINKLER, Kolbermoor (DE); Anthimos GIAPOULIS, Traunstein (DE); Thomas MITTERER, Truchtlaching (DE)

(21) Appl. No.: 19/642,257

(22) Filed: Apr. 8, 2026

(30) Foreign Application Priority Data
Apr. 9, 2025 (DE) 10 2025 114 007.3

(51) Int. Cl. B29C 55/06

(52) U.S. Cl. CPC B29C 55/065

(57) ABSTRACT

A longitudinal stretching system for stretching a plastic film in the longitudinal direction M is disclosed including a film inlet and a film outlet as well as at least one stretching area. The stretching area is arranged between the film inlet and the film outlet and includes at least one longitudinal stretching module receiver. The longitudinal stretching system further includes at least one first longitudinal stretching module 100 and a second longitudinal stretching module. The longitudinal stretching modules can each be inserted into the longitudinal stretching module receiver and are mutually exchangeable. The first longitudinal stretching module and the second longitudinal stretching module include stretching rolls, which define at least one stretching gap in each case. The first longitudinal stretching module differs from the second longitudinal stretching module in terms of the number of stretching gaps, a surface of at least one stretching roll and/or a geometry of at least one stretching roll.

### CROSS REFERENCE TO RELATED APPLICATION

This application claims priority to German Patent Application Number DE 10 2025 114 007.3, filed Apr. 9, 2025, the entire contents of which is hereby incorporated by reference.

### FIELD OF THE DISCLOSURE

The present disclosure relates to a modular longitudinal stretching system for stretching a plastic film, a system for manufacturing a plastic film, comprising at least one modular longitudinal stretching system, and a method for stretching a plastic film.

### BACKGROUND

Plastic films, for example packaging films, are typically stretched in at least one direction (monoaxially) or in both directions (biaxially). This means that the plastic film is stretched in its longitudinal and/or transverse direction after extrusion. In this way, very thin plastic films can be manufactured and/or the mechanical properties of the plastic film can be adjusted or improved.

For stretching in the longitudinal direction, the plastic film is typically guided over so-called stretching rolls which define a stretching gap between themselves. A first stretching roll, which is arranged in front of the stretching gap, has a first rotational speed. A second stretching roll, which is arranged after the stretching gap, has a second, higher rotational speed. The different rotational speeds lead to a longitudinal stretching of the plastic film in the stretching gap.

Depending on the type of plastic film and the desired plastic film thickness, it can be necessary to provide multiple stretching steps in the longitudinal direction. By way of example, plastic films, such as PET films, can be stretched in the longitudinal direction with a final thickness of approximately 30 μm in three consecutive stretching steps. In this case, three stretching gaps would thus be provided.

The manufacture of thicker plastic films, with a plastic film thickness of 100 μm, for example, can require only one stretching step. Thus one stretching gap is sufficient.

As these examples show, there are different, application-specific methods for manufacturing longitudinally stretched or biaxially stretched plastic films, which differ from one another due to the number of stretching steps, for example. Other parameters, such as the temperature, in particular the temperature of the stretching rolls, or the type of surface or the surface coating of the stretching rolls when stretching the plastic film can also vary specific to the application. Different surfaces lead to different adhesive points, abrasion resistances and/or heat conductivities, which influence the quality of the plastic films. Similarly, the required stretching force, for example due to the material of the plastic film, due to the plastic film thickness, and/or due to the desired stretching ratio, can vary. Depending on the required stretching force, different wrap angles of the stretching rolls can be necessary.

This variance means that either very specific longitudinal stretching systems are provided, which are only suitable for a very small spectrum of different plastic films, for example thin PET films (d<30 μm).

In order to be able to cover a larger spectrum of plastic films with only one longitudinal stretching system, universal longitudinal stretching mechanisms, which comprise different rolls, are known. Depending on the desired plastic film product, different rolls can be used for the longitudinal stretching. The remaining rolls not needed for the longitudinal stretching are then used as so-called transfer rolls, which guide the plastic film, but do not stretch it further. These universal longitudinal stretching mechanisms allow the manufacture of a larger spectrum of products, but the plastic film quality is often reduced in comparison with specific longitudinal stretching systems. This is partly due to the fact that the plastic film is guided across an unnecessarily high number of rolls.

In principle, it is also possible to exchange the stretching rolls of a specific longitudinal stretching system in order to modify the longitudinal stretching system for a new type of plastic film. This is associated with long set-up times, however, such that this is often uneconomical. In particular, it is not possible to quickly change the plastic film product in the system in this case.

### SUMMARY

Against this background, an aspect of the present disclosure is to provide an improved longitudinal stretching system and an improved system for manufacturing a plastic film which in particular enables different plastic films to be manufactured or stretched and offers a high plastic film quality at the same time.

In particular there is provided a longitudinal stretching system, a system for manufacturing a plastic film and a method according to the pending claims. Further aspects of the present disclosure are mentioned in the dependent claims, as well as in the following description. In particular, there is provided a longitudinal stretching system for stretching a plastic film in the longitudinal direction. The longitudinal stretching system comprises a film inlet and a film outlet and a stretching area.

The film inlet serves to receive a plastic film, for example from a casting unit. The film outlet serves to discharge the plastic film from the longitudinal stretching system. After the longitudinal stretching system, the plastic film can be stretched in the transverse direction and/or wound, for example.

The stretching area is arranged between the film inlet and the film outlet and comprises at least one longitudinal stretching module receiver. This is set up to receive a longitudinal stretching module such that this is in an operating position. Thus, a longitudinal stretching module received in the longitudinal stretching module receiver can be used to stretch the plastic film in the longitudinal direction.

The longitudinal stretching system further comprises at least one first longitudinal stretching module and a second longitudinal stretching module. Further longitudinal stretching modules, for example a third longitudinal stretching module, can also be provided.

The longitudinal stretching modules can be used in the longitudinal stretching module receiver and can be exchanged with one another. Thus, different longitudinal stretching modules for stretching the plastic film in the longitudinal direction can be used in the longitudinal stretching system, depending on which of the longitudinal stretching modules is inserted in the longitudinal stretching module receiver (i.e. in an operating position).

The first longitudinal stretching module comprises first stretching rolls, which define at least one stretching gap. The second longitudinal stretching module comprises second stretching rolls, which define at least one stretching gap. The stretching gap of the second longitudinal stretching module is different from the at least one stretching gap of the first longitudinal stretching module. The stretching rolls can be held, in particular mounted, in a frame and/or housing of the corresponding longitudinal stretching module.

In accordance with the present disclosure, the first longitudinal stretching module differs from the second longitudinal stretching module in at least one of the following parameters:
number of stretching gaps;
a surface of at least one stretching roll; and/or,
in a geometry of at least one stretching roll.

Furthermore, the first longitudinal stretching module and the second longitudinal stretching module can differ in terms of the number and arrangement of heating elements (for example, IR emitters).

Since the longitudinal stretching system comprises different longitudinal stretching modules which can be inserted into the longitudinal stretching module receiver, different plastic films can be manufactured or stretched in the longitudinal stretching system with higher quality. In particular, different stretching processes can be implemented in a simple manner, since the individual longitudinal stretching modules can be specifically adjusted to a certain stretching process.

The insertion or exchange of the longitudinal stretching modules in the longitudinal stretching module receiver can additionally occur significantly more quickly than, for example, the exchange of conventional stretching rolls. This is in particular possible as the entire longitudinal stretching module is removed from the stretching area (or the longitudinal stretching module receiver) and a second, other longitudinal stretching module can be inserted into the same receiver.

In one aspect, the longitudinal stretching system is set up such that the stretching of the plastic film in the longitudinal direction exclusively occurs in the longitudinal stretching module which is received in the longitudinal stretching module receiver. According to this aspect, no further stretching steps are implemented in the remaining longitudinal stretching systems, in particular no further stretching gaps. The stretching in the longitudinal direction can thus occur with higher quality in the specific longitudinal stretching module. It is also possible that the longitudinal stretching system comprises at least one further stretching gap which is arranged upstream or downstream of the longitudinal stretching module receiver.

By way of example, the first longitudinal stretching module can comprise more stretching gaps than the second longitudinal stretching module. In particular, the first longitudinal stretching module can comprise at least two stretching gaps, or at least three stretching gaps. The second longitudinal stretching module can comprise exactly one stretching gap, for example.

In this way, on the one hand, a multi-step stretching process can be executed in the longitudinal stretching system, and on the other hand, a one-step stretching process can be executed.

In principle, there are different stretching processes with which a plastic film, for example a PET plastic film, can be stretched in a longitudinal stretching system. The stretching process that produces the best plastic film quality depends in particular on the desired plastic film product or plastic film type.

For plastic films, in particular PET films, with a plastic film thickness in the range of from 5 μm to 40 μm, or in the range of from 6 μm to 35 μm, the plastic film is stretched in multiple steps, i.e. in multiple consecutive stretching gaps.

A multi-step stretching process can use, for example, three stretching gaps, wherein the stretching ratio can be different in each of the stretching gaps. It is also possible, for example, to provide four stretching gaps, 5 stretching gaps or more stretching gaps.

By way of example, a stretching gap, which is first passed by the plastic film, has a first stretching ratio. Subsequent stretching gaps, such as a second or third stretching gap, can have a second, other stretching ratio. In particular, the stretching ratio of a subsequent stretching gap can be smaller than, larger than or equal to the stretching ratio of a directly preceding stretching gap.

In a three-step stretching process, the stretching ratios of the respective stretching gaps can be selected as follows, for example, such that it results in an overall stretching ratio of approximately 4:1; the plastic film has thus been elongated by a factor of approximately 4.

Stretching ratio of the first stretching gap: e.g. 1.1:1.

Stretching ratio of the second stretching gap: e.g. 1.5:1 or 2.4:1.

Stretching ratio of the third stretching gap: e.g. 2.5:1 or 1.7:1.

It is understood that the above stretching ratios are only exemplary and are not to be understood as limiting.

In this example, the thickness of the plastic film at the start of the longitudinal stretching (=casting film thickness) can lie in the range of from 100 μm to 400 μm. After the three-step stretching process is carried out, this mono-axially stretched plastic film can then have a thickness in the range of from approximately 25 μm to 90 μm. By means of a subsequent stretching in the transverse direction, the thickness of the plastic film can be reduced to 5 μm to 40 μm, for example.

For plastic films, in particular PET films, with a plastic film thickness in the range of from 30 μm to 330 μm, the plastic film can also be stretched in one single step, i.e. in one stretching gap. The stretching ratio can be, for example, approximately 3:1.

In this example, the thickness of the plastic film at the start of the longitudinal stretching (=casting film thickness) can lie in the range of from 300 μm to 3200 μm. After the one-step stretching process is carried out, this mono-axially stretched plastic film can then have a thickness in the range of from approximately 100 μm to 1000 μm. By means of a subsequent stretching in the transverse direction, the thickness of the plastic film can be reduced to 30 μm to 330 μm, for example.

In such a one-step stretching process, the plastic film is stretched at temperatures, for example, which are below the temperatures of a multi-step stretching process.

In order to temperature control the plastic film to be stretched, the first longitudinal stretching module and/or the second longitudinal stretching module can comprise at least one heating element. The at least one heating element can be, for example, an IR heating element, a fan heater or similar.

By way of example, a heating element can be arranged on at least one side of the plastic film, or heating elements can be arranged on both sides of the plastic film, in particular opposite each other. In addition, the at least one heating element can be assigned to a stretching gap. If multiple stretching gaps are provided, each stretching gap can be assigned at least one heating element.

In a further aspect, at least one stretching roll, a section of the stretching rolls, or all stretching rolls can be a heatable stretching roll. In this way, the plastic film can be temperature controlled for stretching. Typically, the film is pre-heated or temperature controlled to a desired film temperature for longitudinal stretching. Alongside heatable stretching rolls, the temperature controlling can also take place by means of heating elements, such as IR emitters or fan heaters.

In a multi-step stretching process, the at least one stretching roll or the stretching rolls can be temperature controlled to a temperature which lies in the range of from 100° C. to 130° C. The ideal temperature is dependent on the material, among other things. For the manufacture of a thin PET film, the temperature can be in the range of from 110° C. bis 120° C., for example.

For a one-step stretching process, the at least one stretching roll or the stretching rolls can be temperature controlled to a temperature which lies in the range of from 70° C. to 100° C. For the manufacture of a thick PET film, the temperature can be in the range of from 80° C. bis 90° C., for example.

In order to achieve a high plastic film quality and a uniform stretching in the longitudinal direction, the stretching roll(s) can have a surface which comprises one of the following:
a galvanic coating (for example, chrome);
polytetrafluorethylene;
a fluoropolymer coating;
carbide (for example, tungsten carbide); and/or,
ceramic.

It is clear that rolls coated with fluoropolymer are suitable for stretching processes with a temperature of >100° C. In particular, modified fluoropolymer coatings, such as Tfe-Lok® coatings, have been proven to be advantageous.

Carbide or ceramic-coated rolls are suitable, on the other hand, for one-step stretching processes, which are carried out at lower temperatures (<100° C).

It is understood that any single-or multi-layer plastic films can be stretched in the longitudinal stretching systems described here. These can comprise one of the following materials, for example, but are not limited to these: polyethylene (PE), such as LDPE (low-density polyethylene) or HDPE (high-density polyethylene), polypropylene (PP), polyester (PET), polyvinylchloride (PVC), polystyrene (PS), and/or polyamide (PA).

Furthermore, at least one stretching roll of the first and/or second longitudinal stretching module can be set up to be translationally displaceable. The translational displacement can in particular be possible in a direction transverse to the axial direction of the stretching roll, such that a free film length can be set in the stretching gap.

Furthermore, the first and/or second longitudinal stretching module can be set up to guide the plastic film through the longitudinal stretching module along at least two different paths. In this way, for example, different wrap angles can be implemented in a single longitudinal stretching module.

In addition, the first and/or second longitudinal stretching module can comprise at least one transfer roll, which is set up to redirect the plastic film. The at least one transfer roll can precede or follow a stretching roll. Furthermore, the at least one transfer roll of the first and/or second longitudinal stretching module can be set up to be translationally displaceable. The translational displacement can in particular be possible in a direction transverse to the axial direction of the transfer roll, such that a free film length can be set in the stretching gap.

In addition, the first and/or second longitudinal stretching module can comprise at least one nip roll. The nip roll can be assigned to a stretching roll or a transfer roll and be arranged such that the nip roll presses the plastic film onto the stretching roll or the transfer roll.

In one aspect, the stretching roll(s) is/are driven rolls. The drive can occur directly or indirectly. Similarly, the at least one nip roll can be driven (directly or indirectly). The drive can be part of the corresponding longitudinal stretching module. Alternatively, the drive can also be part of the corresponding longitudinal stretching system. In this case, the stretching roll(s) can be connected to the drive via a corresponding coupling and/or a shaft (in particular a drive shaft). In addition, the first and/or second longitudinal stretching module can comprise at least one supply connection. The longitudinal stretching module receiver can comprise a complementary supply connection, which can be coupled to the supply connection if the longitudinal stretching module is received in the longitudinal stretching module receiver. This supply connection can be set up to supply the longitudinal stretching module with air (in particular pressurised air), water (in particular temperature-controlled water), oil (in particular temperature-controlled oil and/or hydraulic oil), electrical energy and/or mechanical energy. The supply connection or the supply connections can comprise quick coupling systems which enable a tool-free connection. Similarly, different connections can be combined in one connection. By way of example, a combined plug connection element can be provided, which can conduct electrical energy as well as air and/or oil.

The at least one supply connection enables the set-up times to be reduced when changing a longitudinal stretching module. Furthermore, the longitudinal stretching module can then also be supplied with, for example, electrical energy and/or a temperature-controlled fluid (e.g. water or oil) if it is not in use, but is temporarily stored in a longitudinal stretching module mounting receiver. This allows the longitudinal stretching module to be temperature controlled before it is inserted into the longitudinal stretching module receiver. The set-up times can thus be further reduced.

Furthermore, the first and/or second longitudinal stretching module can comprise at least one centring element. The longitudinal stretching module receiver can comprise at least one complementary centring element. The centring element and the complementary centring element can engage in such a way if the longitudinal stretching module is received in the longitudinal stretching module receiver in order to determine a position and/or orientation of the longitudinal stretching module. In particular, the centring element and the complementary centring element can engage in a form-fitting manner. In particular, the centring element can provide an axial and/or radial centring. If multiple centring elements are provided, a first centring element can provide an axial centring and a second centring element can provide a radial centring.

In one aspect, the longitudinal stretching system comprises a pre-heating area located upstream of the stretching area. The plastic film can thus be temperature controlled to a pre-defined, desired temperature before stretching in the longitudinal direction. In addition, the longitudinal stretching system can comprise a cooling area which is located downstream of the stretching area. The longitudinally stretched plastic film can be cooled in the cooling area before it is further processed, for example transversely stretched.

In addition, the longitudinal stretching system can comprise a feeder chain which is set up to feed the plastic film into the longitudinal stretching system. This simplifies the feeding of the plastic film when starting operation of the longitudinal stretching system or re-feeding the plastic film after a malfunction, such as a film tear.

The longitudinal stretching system can optionally comprise at least one chain gripper. Such a chain gripper can be arranged upstream of the film inlet and/or downstream of the film outlet. The chain gripper enables the feeder chain to be held while the longitudinal stretching module is changed. For this purpose, the opening of the feeder chain in the area of the longitudinal stretching module receiver is typically necessary. In order to prevent the feeder chain from sliding out of the stretching area when this is open, the chain grippers can hold the chain.

In particular, the at least one chain gripper can be set up to grip the feeder chain in such a way that a movement of the feeder chain in a direction that points away from the stretching area is blocked. In this way, the feeder chain sliding out of the stretching area can be prevented. A feeding of the feeder chain into the stretching area can, however, still be possible, even if the chain gripper has gripped the feeder chain. For this purpose, the chain gripper can have, for example, a gripper jaw having a toothing (for example, saw tooth geometry), which blocks the chain in one direction and releases it in the other direction.

Furthermore, the first and/or second longitudinal stretching module can comprise a replaceable wear assembly, wherein the wear assembly comprises two rolls, in particular stretching rolls. The stretching rolls, which are subject to wear, can thus be replaced quickly.

In one aspect, the longitudinal stretching system further comprises at least one longitudinal stretching module mounting receiver and/or at least one wear assembly mounting receiver. The at least one longitudinal stretching module mounting receiver can be set up to temporarily mount a longitudinal stretching module not received in the longitudinal stretching module receiver and optionally temperature control it. The at least one wear assembly mounting receiver can correspondingly be set up to have a wear assembly available and optionally temperature control it.

The temperature controlling can occur actively or passively. An active temperature controlling comprises, for example, the supply of electrical energy and/or thermal energy (for example, in the form of a temperature-controlled fluid) in order to specifically control the temperature of a longitudinal stretching module received in the longitudinal stretching module mounting receiver and/or a wear assembly received in the wear assembly mounting receiver. In this way, the longitudinal stretching module/the wear assembly can be temperature controlled to a desired temperature. This can correspond to the operating temperature of the stretching process. Heating up the longitudinal stretching module/the wear assembly in the operating position can thereby be shortened or even omitted. In this way, the time needed to replace the longitudinal stretching module or the wear assembly is reduced.

Passive temperature controlling can be achieved by the longitudinal stretching module mounting receiver or the wear assembly mounting receiver being arranged with respect to the longitudinal stretching system such that the waste heat of the longitudinal stretching system at least preheats a longitudinal stretching module received in the longitudinal stretching module mounting receiver and/or a wear assembly received in the wear assembly mounting receiver. The longitudinal stretching module mounting receiver or the wear assembly mounting receiver can be arranged, for example, directly above a preheating area.

Further, there is provided a system for manufacturing a plastic film, wherein the system comprises a longitudinal stretching system of the type previously described. In this way, the above-mentioned advantages can be achieved. In addition, the system for manufacturing a plastic film can comprise an extrusion system, a casting unit and/or a transverse stretching system.

A method for stretching a plastic film in the longitudinal direction is also provided. The method comprises at least the following steps:
inserting a longitudinal stretching module into a longitudinal stretching module receiver of a longitudinal stretching system;
introducing an extruded plastic film into the longitudinal stretching system; and,
stretching the plastic film in the longitudinal direction by means of the inserted longitudinal stretching module. By exchanging the longitudinal stretching module, different plastic films of higher quality can be produced.

### BRIEF DESCRIPTION OF THE DRAWINGS

The present disclosure is explained in more detail below by way of example using the accompanying figures.

FIG. 1 is a schematic depiction of a system for manufacturing a plastic film.

FIG. 2 is a universal longitudinal stretching mechanism from the prior art.

FIG. 3 is a schematic depiction of a longitudinal stretching system according to the present disclosure.

FIG. 4A is a schematic depiction of a first longitudinal stretching module.

FIG. 4B is a schematic depiction of the first longitudinal stretching module.

FIG. 5 is a schematic depiction of a second longitudinal stretching module.

FIG. 6 is a schematic depiction of a longitudinal stretching module having a feeder chain.

FIG. 7 is a schematic flow diagram of a method according to the present disclosure.

### DETAILED DESCRIPTION

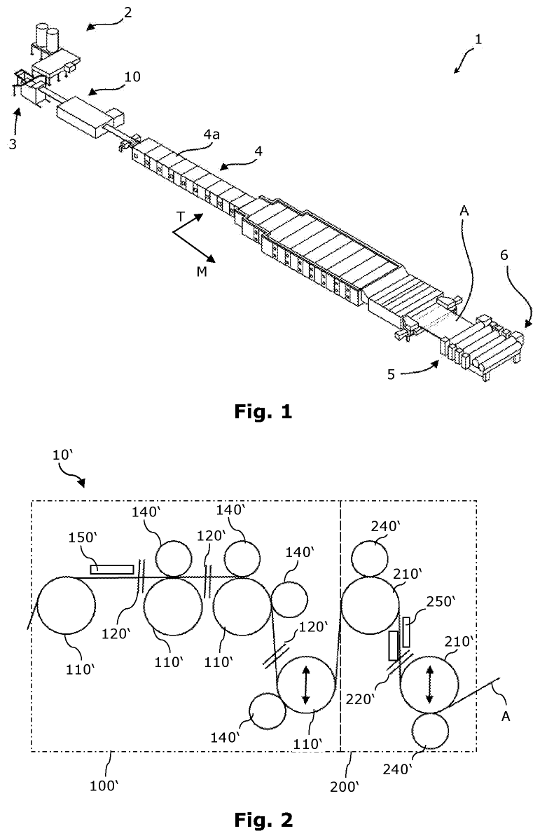

FIG. 1 depicts, highly schematically, a system 1 for manufacturing a plastic film A, which comprises multiple different systems and devices.

The system 1 is, for example, a plastic film manufacturing system for manufacturing a plastic film, for example a packaging film, on the basis of which—without limiting the scope of protection—the present disclosure is explained by way of example.

In the example shown, the system 1 has an extrusion system 2, a casting unit 3, at least one longitudinal stretching system 10 (MDO, machine direction orienter), a transverse stretching system 4 (TDO, transverse direction orienter), a treatment device 5 and a wrapping device 6. The extrusion system 2 has an extruder and is set up to generate a melt from at least one starting product (for example, plastic granulate and/or recyclate), which is applied to a cooling roller of the casting unit 3, whereby a plastic film A is generated. This extruded, not yet stretched plastic film is also referred to as a cast film and can have a thickness in the range of from 50 μm to 3200 μm, in particular in the range of from 100 μm to 500 μm.

The generated plastic film A can have one or multiple layers. It is conceivable in the case of a multi-layer plastic film that an extruder generates multiple or all layers, or that an extruder is provided for each layer.

By way of example, the extruder(s) is/are a single-screw extruder, a cascade extruder and/or a twin-screw extruder.

It is also conceivable that other mixing and processing units, such as a Buss kneader or a planetary roller extruder, are used.

The cooling roller contained in the casting unit 3 is temperature controlled.

The transverse stretching system 4, as is described by way of example in DE 10 2021 128 332 A1, has a furnace 4a with different zones for temperature controlling the plastic film along the usual movement-or withdrawal direction of the system 1.

The transverse stretching system 4 has a drive system for the plastic film A having two transport rails in order to convey the plastic film through the different zones. A plurality of clip units are guided on each of the transport rails in a known manner.

The clip units can grip the plastic film A and be moved by means of a suitable drive along the transport rail such that the plastic film A is conveyed through the transverse stretching system 4.

In the first zone, also called the preheating zone, the plastic film is heated. In the subsequent second zone (“stretching zone”), the plastic film is stretched in the transverse direction, such that it has a larger width and is thinner at the end of the second zone than at the start. The stretching occurs by the distance of the rails of the of the drive system in the stretching zone being increased.

In the third and further zones (called the “heat treatment zone”, “further heating zone” and/or “annealing zone”), a relaxation of the plastic film at high temperatures can occur, for example. In the final zone (“cooling zone”), the plastic film is cooled.

A further zone is called the neutral zone and serves to separate the zones. The neutral zone is, for example, an empty space without ventilation. The neutral zone can be located between the respective previously described zones, for example between the annealing zone and the cooling zone.

Such a transverse stretching system 4 is known from WO 2014/094803 A1, for example. The zones of the transverse stretching systems 4 can also be differently distributed and/or executed differently in terms of their length. By way of example, fewer or shorter neutral zones can be provided or the neutral zones can be arranged at other points, additionally too. Other changes to the remaining zones are also conceivable.

The treatment device 5 is, for example, a device for activating the surface of the plastic film A by means of a corona treatment, for example in order to implement better printability or metal adhesion. The corona treatment can occur on one side or on both sides.

The wrapping device 6 serves to wind the generated plastic film A and is the last device in the withdrawal direction. It has a winding core on which the plastic film A is wound. FIG. 2 shows a universal longitudinal stretching mechanism 10′ from the prior art. This longitudinal stretching mechanism 10′ is in principle suited to be able to manufacture plastic films of different thicknesses with only one longitudinal stretching system. For this purpose, the longitudinal stretching mechanism 10′ comprises different rolls.

The stretching rolls 110′ are assigned to a first section 100′ and form three stretching gaps 120′ between them. Optionally, nip rolls 140′ can also be provided, which press the plastic film A onto the stretching rolls 110′.

Further stretching rolls 210′ are assigned to a second section 200′. The two stretching rolls 210′ form the stretching gap 220′ between them. The plastic film A can be pressed against the stretching rolls 210′ by means of the nip rolls 240′. Furthermore, heating elements 150′, 250′ can be provided, which control the temperature of the plastic film A.

Using the shown universal longitudinal stretching mechanism 10′, plastic films can be stretched in the longitudinal direction in a multi-step stretching process or a one-step stretching process. For a multi-step stretching process, the first area 100′ is active. This means that the stretching rolls 110′ are rotated at different rotational speeds in order to achieve the stretching in the three shown stretching gaps. The stretching rolls 210′ are used as transfer rolls in this case, i.e. they rotate at the same speed. In the second section 200′, there is thus no further stretching.

For a one-step stretching process, the second area 200′ is active. This means that the stretching rolls 210′ are rotated at different rotational speeds in order to achieve the stretching in the stretching gap 220′. In this case, the stretching rolls 110′ are used as transfer rolls, i.e. they rotate at the same speed. In the first section 100′, there is thus no stretching.

This universal longitudinal stretching mechanism allows the manufacture of films of different thicknesses, but the plastic film quality is often reduced as the plastic film has to be guided over an unnecessarily high number of rolls and thus scratches or similar can easily occur on the plastic film.

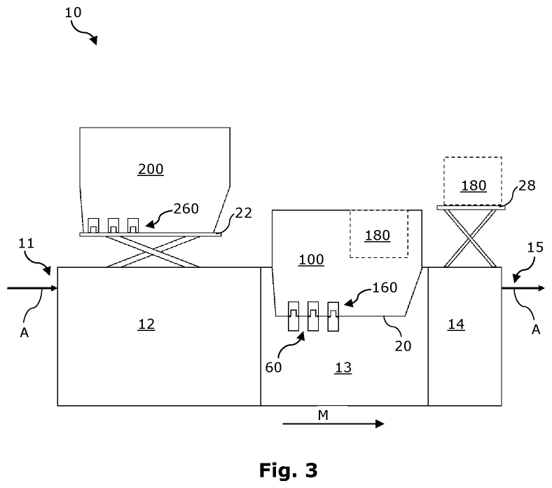

FIG. 3 shows a schematic depiction of a longitudinal stretching system 10. The longitudinal stretching system 10, which is typically arranged downstream of a casting unit 4, comprises a film inlet 11 for receiving the plastic film A and a film outlet 15 for outputting the longitudinally stretched plastic film. An optional pre-heating area 12, a stretching area 13 and an optional cooling area are arranged between the film inlet 11 and the film outlet 15.

The temperature in the pre-heating area can be, for example, equal to or greater than 110° C., in particular equal to or greater than 120° C., and/or equal to or less than 155° C., in particular equal to or less than 145° C. The temperature in the stretching area can be, for example, equal to or greater than 140° C., in particular equal to or greater than 150° C., and/or equal to or less than 165° C., in particular equal to or less than 155° C.. The temperature of the corresponding areas is understood, for example, as the temperature of the rolls in the corresponding areas, or alternatively even the temperature of the film in the respective area.

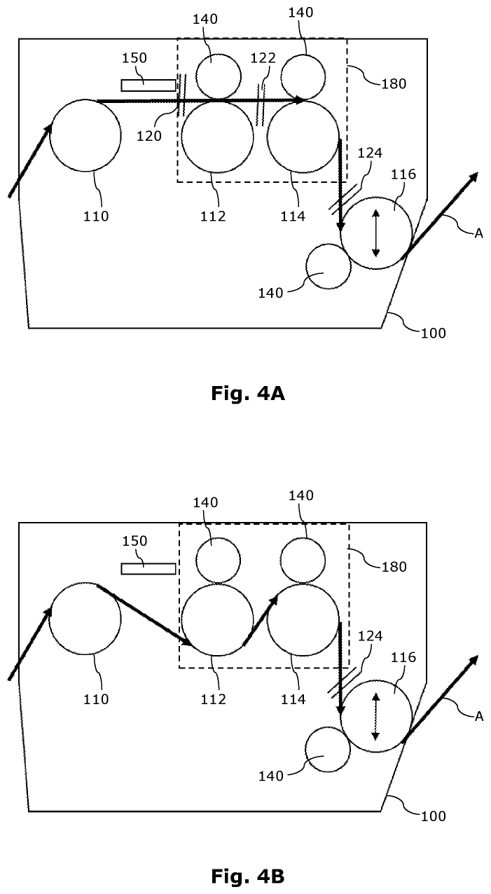

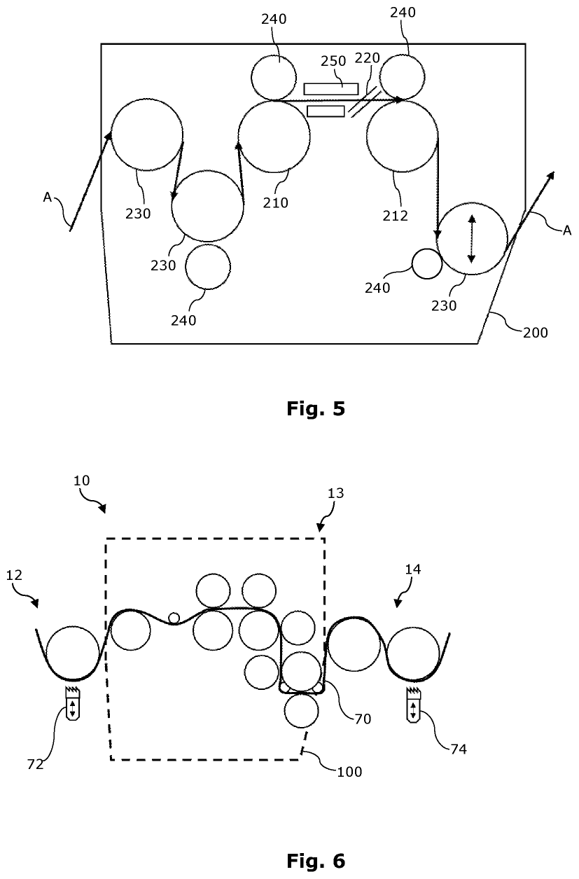

The stretching area comprises at least one longitudinal stretching module receiver 20. A longitudinal stretching module 100 can be received, as shown, in this longitudinal stretching module receiver 20 in an operating position. This longitudinal stretching module 100 can be, as explained by way of example with reference to FIGS. 4A and 4B, set up to execute a multi-step stretching process. Thus, very thin films (final film thickness in the range of 5 μm-40 μm, for example) can be manufactured by means of the longitudinal stretching module 100. If thicker films are to be manufactured, the longitudinal stretching module 100 can be replaced by the longitudinal stretching module 200. This longitudinal stretching module 200 can be, as explained by way of example with reference to FIG. 5, set up to execute a one-step stretching process.

The first longitudinal stretching module 100 differs from the second longitudinal stretching module 200, for example, in terms of the number of stretching gaps, a surface of at least one stretching roll and/or a geometry of at least one stretching roll.

In order to temporarily store the longitudinal stretching module 200 not required at that moment, a longitudinal stretching module mounting receiver 22 can be provided. In the shown example, this serves not only as temporary storage, but also to temperature control the longitudinal stretching module 200. The temperature control can occur passively on the one hand, since the longitudinal stretching module mounting receiver 22 is arranged in the immediate vicinity (here above) the cooling area 12. Additionally, an active temperature control can also occur. For this purpose, the longitudinal stretching module 200 can be supplied with electrical energy and/or a temperature-controlled fluid (air, water, oil . . . ) via the supply connection 260, for example.

In order to be able to supply energy to the longitudinal stretching module 100, which is in operation and inserted into the longitudinal stretching module receiver 20, for example, the longitudinal stretching module 100 can comprise a supply connection 160. The longitudinal stretching module receiver 20 can comprise at least one complementary supply connection 60, which can be coupled to the supply connection 160 of the longitudinal stretching module 100 as well as to the supply connection 260 of the longitudinal stretching module 200, if the corresponding longitudinal stretching module 100, 200 is received in the longitudinal stretching module receiver 20. In addition to energy (electrical, mechanical energy), the longitudinal stretching module 100 can also be supplied with at least one fluid, such as air, water and/or oil, electrical energy and/or mechanical energy via the supply connection. In addition, data can also be transferred from and/or to the longitudinal stretching module. By way of example, the longitudinal stretching module can comprise an identifier which is read in the longitudinal stretching module receiver in order to correspondingly adapt the stretching process, in particular parameters, such as film temperature, roll temperature, roll speed, to the inserted longitudinal stretching module.

FIGS. 4A and 4B show a longitudinal stretching module 100, which is set up for a multi-step stretching process. The depiction in FIGS. 4A and 4B differs in the type of film guidance. In FIG. 4A, the plastic film A is guided substantially in a straight line across the stretching roll 112 (wrap angle of approximately 0°). In FIG. 4B, the plastic film is guided about the stretching roll 112 (wrap angle of approximately 90°).

The longitudinal stretching module 100 comprises four stretching rolls 110, 112, 114, 116. These define three stretching gaps 120, 122, 124. The roll speed of the stretching rolls 110, 112, 114, 116 can be selected in such a way that the stretching ratio is different in each of the stretching gaps 120, 122, 124. In order to ensure that the plastic film fits well against the stretching rolls 110, 112, 114, 116, one or multiple nip rolls 140 can be provided. In addition, the plastic film can be temperature-controlled by means of a heating element 150, for example. The longitudinal stretching module shown in FIGS. 4A and 4B further comprises a replaceable wear assembly 180 (see the dashed line). This can comprise, for example, the stretching rolls 112, 114, which are subjected to a high degree of wear. The replaceable wear assembly 180 thus enables the wear components, in particular the stretching rolls 112, 114, to be exchanged together and thus quickly. In addition, as FIG. 3 shows, a wear assembly mounting receiver 28 can be provided, which is set up to have a further wear assembly 180 available and optionally temperature control it.

FIG. 5 shows a longitudinal stretching module 200, which is set up for a one-step stretching process. The longitudinal stretching module 200 comprises two stretching rolls 210, 212. These define a stretching gap 220. The roll speed of the stretching rolls 210, 212 can be selected such that a desired stretching ratio is set in the stretching gap 220. In order to ensure that the plastic film fits well against the stretching rolls 210, 212, one or multiple nip rolls 240 can be provided. In addition, the plastic film can be temperature-controlled by means of a heating element 250, for example. The embodiment shown here additionally comprises optional transfer rolls 230. As FIG. 6 shows, the longitudinal stretching system 10 can comprise a feeder chain 70. Furthermore, chain grippers 72, 74 can be provided. The chain gripper 72 is arranged upstream of the stretching area 13. The chain gripper 74 is arranged downstream of the stretching area 13. The chain grippers 72, 74 enable the feeder chain 70 to be held while the longitudinal stretching module 100, 200 is exchanged. In order to prevent the feeder chain 70, which is opened when exchanging the longitudinal stretching module, from sliding out of the stretching area 13, the chain grippers 72, 74 hold the chain.

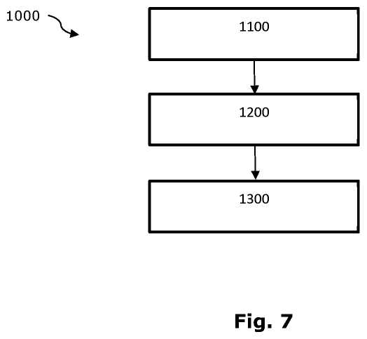

FIG. 7 shows a schematic flow diagram of a method 1000 according to the present disclosure for stretching a plastic film A in the longitudinal direction M. The method 1000 comprises at least the following steps:
inserting 1100 a longitudinal stretching module 100, 200 into a longitudinal stretching module receiver 22 of a longitudinal stretching system 10;
introducing 1200 an extruded plastic film (for example, a cast film) into the longitudinal stretching system 10; and;
stretching 1300 the plastic film in the longitudinal direction M by means of the inserted longitudinal stretching module 100, 200.

By exchanging the longitudinal stretching module, different plastic films of higher quality can be produced.

1. A longitudinal stretching system for stretching a plastic film in the longitudinal
direction, comprising:
a film inlet;
a film outlet;
a stretching area;
wherein the stretching area is arranged between the film inlet and the film outlet;
wherein the stretching area comprises at least one longitudinal stretching module receiver configured to receive a longitudinal stretching module in an operating position;
at least one first longitudinal stretching module and a second longitudinal stretching module;
wherein the first and the second longitudinal stretching modules are configured to be inserted into the longitudinal stretching module receiver and are mutually exchangeable;
wherein the first longitudinal stretching module comprises first stretching rolls defining at least one stretching gap;
wherein the second longitudinal stretching module comprises second stretching rolls defining at least one stretching gap; and,
wherein the first longitudinal stretching module differs from the second longitudinal stretching module by at least one of the number of stretching gaps, a surface of at least one stretching roll, or a geometry of at least one stretching roll.

2. The longitudinal stretching system according to claim 1, wherein the longitudinal stretching system is configured such that the stretching of the plastic film in the longitudinal direction exclusively occurs in the longitudinal stretching module which is received in the longitudinal stretching module receiver.

3. The longitudinal stretching system according to claim 1, wherein the first longitudinal stretching module comprises at least two stretching gaps or at least three stretching gaps; and/or, wherein the second longitudinal stretching module comprises exactly one stretching gap.

4. The longitudinal stretching system according to claim 1, wherein the first longitudinal stretching module and/or the second longitudinal stretching module comprises at least one heating element which is set up to control the temperature of the plastic film; and/or, Wherein at least one stretching roll is a heatable stretching roll.

5. The longitudinal stretching system according to claim 1, wherein at least one of the stretching rolls has a surface which comprises at least one of the following:
a galvanic coating;
polytetrafluorethylene;
a fluoropolymer coating;
carbide; or,
ceramic.

6. The longitudinal stretching system according to claim 1, wherein at least one stretching roll of the first and/or second longitudinal stretching module is configured to be translationally displaceable.

7. The longitudinal stretching system according to claim 1, wherein the first and/or second longitudinal stretching module is configured to guide the plastic film along at least two different paths through the longitudinal stretching module.

8. The longitudinal stretching system according to claim 1, wherein the first and/or second
longitudinal stretching module comprises at least one supply connection;
wherein the longitudinal stretching module receiver comprises at least one complementary supply connection coupled to the supply connection if the longitudinal stretching module is received in the longitudinal stretching module receiver;
wherein the supply connection is set up to supply the longitudinal stretching module with air, water, oil, electrical energy and/or mechanical energy and/or to enable a data communication.

9. The longitudinal stretching system according to claim 1, wherein the first and/or second
longitudinal stretching module comprises at least one centring element;
wherein the longitudinal stretching module receiver comprises at least one complementary centring element; and,
wherein the centring element and the complementary centring element engage if the longitudinal stretching module is received in the longitudinal stretching module receiver in order to determine a position and/or orientation of the longitudinal stretching module.

10. The longitudinal stretching system according to claim 1, further comprising a pre-heating area which is arranged upstream of the stretching area, and/or a cooling area arranged downstream of the stretching area.

11. The longitudinal stretching system according to claim 1, further comprising a feeder chain configured to feed the plastic film into the longitudinal stretching system;
Wherein the longitudinal stretching system further comprises at least one chain gripper disposed upstream and/or downstream of the stretching area; and,
wherein the at least one chain gripper is configured to grip the feeder chain in such a way that a movement of the feeder chain in a direction that points away from the stretching area is blocked.

12. The longitudinal stretching system according to claim 1, wherein the first and/or second longitudinal stretching module comprises a replaceable wear assembly, wherein the wear assembly comprises at least two rolls, in particular stretching rolls.

13. The longitudinal stretching system according to claim 1, further comprising at least one
longitudinal stretching module mounting receiver and/or at least one wear assembly mounting receiver;
wherein the at least one longitudinal stretching module mounting receiver is configured to temporarily mount a longitudinal stretching module not received in the longitudinal stretching module receiver and temperature control it; and,
wherein the at least one wear assembly mounting receiver is configured to have a wear assembly available and temperature control it.

14. A system for manufacturing a plastic film, comprising:
the longitudinal stretching system according to claim 1;
an extrusion system;
a casting unit; and/or,
a transverse stretching system.

15. A method for stretching a plastic film in the longitudinal direction, comprising:
inserting a longitudinal stretching module into a longitudinal stretching module receiver of the longitudinal stretching system according to claim 1;
introducing an extruded plastic film into the longitudinal stretching system; and,
stretching the plastic film in the longitudinal direction by means of the inserted longitudinal stretching module.
